(19) United States
(12) Patent Application Publication
(10) Pub. No.: US 2024/0182329 A1
(43) Pub. Date: Jun. 6, 2024

(54) ROLL-TYPE DEVICE FOR ELECTROCHEMICAL RECOVERY OF AMMONIA, AND METHOD FOR ELECTROCHEMICAL RECOVERY OF AMMONIA

(71) Applicant: Guangdong University of Technology, Guangzhou (CN)

(72) Inventors: Jinxing MA, Guangzhou (CN); Jiazhou HE, Guangzhou (CN); Kui YANG, Guangzhou (CN); Yewen TAO, Guangzhou (CN); Jieqin ZHOU, Guangzhou (CN); Wanrui ZHANG, Guangzhou (CN); Yinglin LIANG, Guangzhou (CN); Daoyuan ZU, Guangzhou (CN); Zhifeng YANG, Guangzhou (CN)

(73) Assignee: Guangdong University of Technology, Guangzhou (CN)

(21) Appl. No.: 18/231,266

(22) Filed: Aug. 8, 2023

(30) Foreign Application Priority Data
Dec. 2, 2022 (CN) 202211539677.3

(51) Int. Cl. C02F 1/469; C02F 1/461

(52) U.S. Cl. CPC C02F 1/469; C02F 1/46104; C02F 2001/46161; C02F 2001/46171; C02F 2101/16

(57) ABSTRACT

A roll-type device for electrochemical recovery of ammonia is provided, including: a central tube and a tubular shell, where a hydrophobic gas membrane and an anion-exchange membrane (AEM) are sequentially wound around the central tube; a first porous flexible electrode and a first guide liner are sequentially wound at an inner side of the hydrophobic gas membrane, and a second porous flexible electrode and a second guide liner are sequentially wound at an inner side of the AEM; an inner side wall of the hydrophobic gas membrane, an outer wall of the central tube, an outer side wall of the AEM, and the tubular shell enclose a closed first electrode liquid flow chamber; and an inner side wall of the AEM, an outer wall of the central tube, an outer side wall of the hydrophobic gas membrane, and the tubular shell enclose a closed second electrode liquid flow chamber.

### CROSS REFERENCE TO THE RELATED APPLICATIONS

This application is based upon and claims priority to Chinese Patent Application No. 202211539677.3, filed on Dec. 2, 2022, the entire contents of which are incorporated herein by reference.

### TECHNICAL FIELD

The present disclosure relates to the technical fields of wastewater treatment and resource recovery, and in particular relates to a roll-type device for electrochemical recovery of ammonia, and a method for electrochemical recovery of ammonia.

### BACKGROUND

As ammonia is an important nutrient for crop growth, the reliable large-scale production of ammonia is an important guarantee for agricultural cultivation and global food supply. Ammonia synthesis in the nature mainly relies on nodule nitrogen-fixing bacteria to absorb nitrogen in the air and convert nitrogen into ammonia nitrogen, but the yield of ammonia synthesized through this pathway can no longer meet the needs of life activities of humans. Since the beginning of the 20th century, the Haber-bosch process has become the most important means of large-scale ammonia synthesis by humans. However, this reaction process requires the large consumption of fossil fuels and leads to the emission of greenhouse gases, which contributes significantly to exacerbating the global warming and the extreme weather frequency. In addition, proteins ingested by humans can be decomposed into urea (ammonia nitrogen) through metabolic activities and then released into the environment, which will cause water eutrophication and serious environmental disasters if not properly treated.

Therefore, if ammonia in wastewater can be collected at the source, subsequent treatment load of the wastewater treatment plant can be significantly reduced, and the collected ammonia can be recycled to meet the needs of production and living of humans. This approach can essentially reduce dependence on the energy-intensive Haber-bosch process to synthesize ammonia, and has promising prospects in green chemistry and sustainable development. According to analytical results of nitrogen components in domestic wastewater and urine, it has been found in academic and industrial communities that urine contributes 75% or more of an ammonia nitrogen load of domestic wastewater, but a volume of urine is only 1% of a total volume of domestic wastewater. The source separation of urine and the recovery of ammonia from urine subjected to source separation is an effective method for recycling of waste nitrogen. Additionally, livestock breeding wastewater includes a large amount of ammonia, which provides an important material base for the recycling of nitrogen.

In recent years, electrochemical water cleaning technologies have gradually been favored by wastewater recycling and green chemical processes due to the advantages of small floor space, simple control, and easy modularization. The electrochemical ammonia recovery technology is an emerging technology (see, Wang Xin et al., CN201910378257, Method for Recovering Nitrate Nitrogen from Wastewater through Microbial Electrochemical Ammonification; and Li Xuewei et al., CN202111391571, Device and Method for Recovering Ammonia Nitrogen from Wastewater through Electrochemical coupling functional membrane). This technology relies on an electric field generated by electric energy to drive ion migration, increases the pH of an ammonia-containing solution through an electrochemical reaction, allows the blow-off separation of an ammonia gas from wastewater through air stripping or membrane air stripping, and allows the absorption of an ammonia gas in an acidic solution.

The current technical principles of electrochemical recovery of ammonia in urine (and in ammonia-containing wastewater) are as follows: 1. Hydrolyzed urine, domestic wastewater, or breeding wastewater is injected into an anode chamber/tank of an electrochemical system, NH₃ in the wastewater reacts with H⁺ generated at the anode to produce NH₄⁺, and driven by an electric field force, NH₄⁺ passes through a cation-exchange membrane (CEM) and moves to a cathode chamber/tank. 2. A large amount of OH⁻ is generated due to an electrochemical reaction at a cathode and reacts with the migrated NH₄⁺ to produce NH₃, and when supersaturated (or reaching a specified partial pressure), NH₃ escapes from a solution 3. The escaped NH₃ gas diffuses through an absorption tower or a hydrophobic gas membrane to an absorption chamber/tank of the electrochemical system, and an exogenous acid solution (such as diluted H₂SO₄) is added to absorb and recover NH₃.

CN202111391571 discloses a device and method for recovering ammonia nitrogen from wastewater through an electrochemical coupling functional membrane, where the device includes a four-chamber electrolytic cell formed through division of a bipolar membrane, an anion-exchange membrane (AEM), and a CEM that are sequentially arranged, and the four-chamber electrolytic cell includes an anode chamber, an acid chamber, a salt chamber, and a cathode chamber; and the method adopts a bipolar membrane unit to generate an acid solution required for absorption of NH_{3(g)}.

Nevertheless, the above-mentioned electrochemical ammonia recovery technologies can only allow ammonia recovery by feeding an additional acid solution or additionally arranging an acid-producing unit, and cannot directly rely on H⁺ generated by an electrode reaction to allow recycling of waste ammonia, which significantly increases the construction and operation costs of a system. Therefore, it is of great significance to develop an electrochemical ammonia recovery device and method with simple configuration and high recovery efficiency.

### SUMMARY

The embodiment of the present disclosure provides a roll-type device for electrochemical recovery of ammonia in urine, domestic wastewater, or breeding wastewater, which can rely on electric energy to efficiently recover ammonia in urine, domestic wastewater, or breeding wastewater without adding any chemical agent.

In order to achieve the objective of the present disclosure, a first aspect of the present disclosure provides a roll-type device for electrochemical recovery of ammonia, including: a central tube and a tubular shell sleeved outside the central tube, where two axial ends of the tubular shell are provided with end caps, respectively, the two end caps are in sealed connection with two ends of the central tube, respectively, and the two end caps each are provided with an avoidance hole communicating with the central tube;
two partition plates that separate an inner hole of the central tube are provided inside the central tube; an axis of the central tube is set as a vertical direction; an upper partition plate and an inner wall of the central tube located above the upper partition plate enclose a first electrode liquid outlet cavity with an upper opening, and a lower partition plate and an inner wall of the central tube located below the lower partition plate enclose a first electrode liquid inlet cavity with a lower opening, the first electrode liquid outlet cavity and the first electrode liquid inlet cavity are separated by the partition plates, and do not communicate with each other in the central tube to prevent short-circuiting;
a hydrophobic gas membrane and an AEM are sequentially wound around the central tube, the hydrophobic gas membrane and the AEM both are located inside the tubular shell, and winding-starting edges of the hydrophobic gas membrane and the AEM both are in sealed connection with an outer wall of the central tube; a winding direction of the hydrophobic gas membrane and the AEM around the central tube is set as a clockwise direction, the winding-starting edge of the AEM is located in a counterclockwise direction of the winding-starting edge of the hydrophobic gas membrane; a first porous flexible electrode and a first guide liner are sequentially wound at an inner side of the hydrophobic gas membrane, and a second porous flexible electrode and a second guide liner are sequentially wound at an inner side of the AEM; it is understandable that, when a winding angle of the hydrophobic gas membrane exceeds an orientation of the winding-starting edge of the AEM, the hydrophobic gas membrane and the first porous flexible electrode and the first guide liner at the inner side of the hydrophobic gas membrane are wound around the AEM, such that the AEM is provided at each of inner and outer sides of the hydrophobic gas membrane; winding-terminating edges of the hydrophobic gas membrane and the AEM both are in sealed connection with an inner wall of the tubular shell; the winding-terminating edge of the AEM is located in a counterclockwise direction of the winding-terminating edge of the hydrophobic gas membrane, edges of upper and lower ends of each of the hydrophobic gas membrane and the AEM each are in sealed connection with the end caps of the two axial ends of the tubular shell, such that an inner side wall of the hydrophobic gas membrane, an outer wall of the central tube extending from the winding-starting edge of the hydrophobic gas membrane in the clockwise direction, an outer side wall of the AEM, and an inner wall of the tubular shell enclose a closed first electrode liquid flow chamber, and an inner side wall of the AEM, an outer wall of the central tube extending from the winding-starting edge of the AEM in the clockwise direction, an outer side wall of the hydrophobic gas membrane, and an inner wall of the tubular shell enclose a closed second electrode liquid flow chamber;
a first partition is provided inside the first electrode liquid flow chamber, and the first partition separates the first electrode liquid flow chamber into a first flow channel, namely, a first electrode liquid flow channel, which can prevent the leakage and mixing of a first electrode liquid;
a second partition is provided inside the second electrode liquid flow chamber, and the second partition separates the second electrode liquid flow chamber into a second flow channel, namely, a second electrode liquid flow channel, which can prevent the leakage and mixing of a second electrode liquid;
the first partition and the first guide liner provide water-distributing and supporting effects for the first electrode liquid flow chamber, and the first guide liner can ensure a uniform flow of an electrode liquid on a porous flexible electrode;
the second partition and the second guide liner provide water-distributing and supporting effects for the second electrode liquid flow chamber, and the second guide liner can ensure a uniform flow of an electrode liquid on a porous flexible electrode;
a top of a side wall of the central tube is provided with an outlet hole allowing the first electrode liquid outlet cavity to communicate with the first flow channel, and a bottom of the side wall of the central tube is provided with an inlet hole allowing the first electrode liquid inlet cavity to communicate with the first flow channel,
a first electrode liquid enters the first electrode liquid flow chamber through the inlet hole at the bottom of the central tube, flows from bottom to top, exits the first electrode liquid flow chamber through the outlet hole at the top of the central tube, and flows out through the first electrode liquid outlet cavity;
an upper part of a side wall of the tubular shell is provided with a second electrode liquid inlet communicating with the second flow channel, and a lower part of the side wall of the tubular shell is provided with a second electrode liquid outlet communicating with the second flow channel; and a second electrode liquid flows in through the second electrode liquid inlet, flows from top to bottom, and flows out through the second electrode liquid outlet.

In the present disclosure, a first electrode liquid flows from the first electrode liquid inlet cavity of the central tube into the first electrode liquid flow chamber at an inner side; a second electrode liquid is injected into the second electrode liquid inlet from an upper side end of the tubular shell, and flows into the second electrode liquid flow chamber; and the first electrode liquid and the second electrode liquid flow independently in respective flow chambers, and are not mixed with each other. In addition, the second electrode liquid flow chamber and the first electrode liquid flow chamber form a closed circuit through the AEM at a side of the second electrode liquid flow chamber.

Optionally, the first electrode liquid is a cathode liquid, the first electrode liquid flow chamber is a cathode liquid flow chamber, the first electrode liquid inlet cavity is a cathode liquid inlet cavity, the first electrode liquid outlet cavity is a cathode liquid outlet cavity, and the first porous flexible electrode is a porous flexible cathode; and
the second electrode liquid is an anode liquid, the second electrode liquid flow chamber is an anode liquid flow chamber, the second electrode liquid inlet is an anode liquid inlet, the second electrode liquid outlet is an anode liquid outlet, and the second porous flexible electrode is a porous flexible anode.

In this case, in the cathode liquid flow chamber at an inner side of the central tube, a large amount of OH is generated near the porous flexible cathode due to an electrochemical reduction reaction to increase a pH of the cathode liquid to 9.3 or more (more than pKₐ (NH₃/NH₄⁺)=9.25) such that NH₄⁺ in the cathode liquid is converted into NH₃, and then NH₃ diffuses to the anode liquid flow chamber through the hydrophobic gas membrane and is captured by H⁺ generated near the porous flexible anode to produce NH₄⁺; and anions (such as Cl⁻ and SO₄²⁻) in the cathode liquid enter the anode liquid flow chamber through the AEM, thereby allowing a charge balance and the recycling of ammonia.

A method for electrochemical recovery of ammonia with the roll-type device for electrochemical recovery of ammonia is provided, including the following steps:

Step 1: Introducing a hydrolyzed cathode liquid from the cathode liquid inlet cavity of the central tube into the first flow channel of the cathode liquid flow chamber through the inlet hole. The cathode liquid includes any one selected from the group consisting of urine, domestic wastewater, and breeding wastewater, and has an ammonia nitrogen concentration of 30 mg/L to 5,000 mg/L, such as 50 mg/L, 100 mg/L, 200 mg/L, 500 mg/L, 1,000 mg/L, or 2,000 mg/L and preferably 100 mg/L to 4,000 mg/L; and the ammonia nitrogen concentration is determined based on N.

Introducing an anode liquid into the anode liquid flow chamber through the anode liquid inlet at an outer upper end of the tubular shell. The anode liquid includes any one selected from the group consisting of tap water, deionized water, and ultrapure water (UPW). The device and method of the present disclosure ensure that the efficient recovery of ammonia can be allowed without adding an acid solution to the anode liquid, but the addition of any one selected from the group consisting of sulfuric acid, hydrochloric acid, nitric acid, carbonic acid, and phosphoric acid of 0 M to 1 M to the anode liquid is also within the protection scope of the present disclosure.

The cathode liquid and the anode liquid flow independently in respective flow channels, are not mixed with each other, and flow in opposite directions. The opposite flow directions of the cathode liquid and the anode liquid have a positive effect for the contact, mass transfer, or the like of materials.

Step 2: In the cathode liquid flow chamber enclosed by an outer side of the central tube and the hydrophobic gas membrane, converting NH₄⁺ in the cathode liquid into NH₃ in an OH⁻ alkaline environment produced at a cathode; and allowing the NH₃ to diffuse to the anode liquid flow chamber enclosed by the hydrophobic gas membrane and the AEM.

Step 3: Generating a large amount of H⁺ through an electrochemical reaction at an anode, absorbing the NH₃ diffusing from the cathode liquid flow chamber to the anode liquid flow chamber, and finally recovering the ammonia nitrogen in a form of an ammonium salt to complete material recovery from urine.

Optionally, the external direct current (DC) power supply provides a current with a density of 1 A/m² to 100 A/m², such as 1 A/m², 5 A/m², 10 A/m², 20 A/m², 50 A/m², or 100 A/m² and preferably 20 A/m² to 80 A/m².

Optionally, a residence time of the cathode liquid in the cathode liquid flow chamber is 10 min to 180 min, such as 10 min. 20 min, 40 min, 60 min, 120 min, or 0 min and preferably 30 min to 120 min.

Optionally, in order to increase a recovered ammonia concentration, a residence time of the anode liquid in the anode liquid flow chamber is 10 min to 60 min, such as 10 min, 20 min, 30 min, 40 min, 50 min, or 60 min and preferably 10 min to 30 min.

Optionally, the first electrode liquid is an anode liquid, the first electrode liquid flow chamber is an anode liquid flow chamber, the first electrode liquid inlet cavity is an anode liquid inlet cavity, the first electrode liquid outlet cavity is an anode liquid outlet cavity, and the first porous flexible electrode is a porous flexible anode; and
the second electrode liquid is a cathode liquid, the second electrode liquid flow chamber is a cathode liquid flow chamber, the second electrode liquid inlet is a cathode liquid inlet, the second electrode liquid outlet is a cathode liquid outlet, and the second porous flexible electrode is a porous flexible cathode.

In this case, in the cathode liquid flow chamber at an outer side, a large amount of OH″ is generated near the porous flexible cathode due to an electrochemical reduction reaction to increase a pH of the cathode liquid to 9.3 or more (more than pKₐ(NH₃/NH₄⁺)=9.25) such that NH₄⁺ in the cathode liquid is converted into NH₃, and then NH₃ diffuses to the anode liquid flow chamber through the hydrophobic gas membrane and is captured by H⁺ generated near the porous flexible anode to produce NH₄⁺; and anions (such as Cl⁻ and SO₄²⁻) in the cathode liquid enter the anode liquid flow chamber through the AEM, thereby allowing a charge balance and the recycling of ammonia.

A method for electrochemical recovery of ammonia with the roll-type device for electrochemical recovery of ammonia is provided, including the following steps:

Step 1: Introducing a hydrolyzed cathode liquid into the second flow channel of the cathode liquid flow chamber through the cathode liquid inlet at the upper part of the side wall of the tubular shell. The cathode liquid includes any one selected from the group consisting of urine, domestic wastewater, and breeding wastewater, and has an ammonia nitrogen concentration of 30 mg/L to 5,000 mg/L, such as 50 mg/L, 100 mg/L, 200 mg/L, 500 mg/L, 1,000 mg/L, or 2,000 mg/L and preferably 100 mg/L to 4,000 mg/L.

Introducing an anode liquid from the anode liquid inlet cavity of the central tube into the first flow channel of the anode liquid flow chamber through the inlet hole. The anode liquid includes any one selected from the group consisting of tap water, deionized water, and UPW. The device and method of the present disclosure ensure that the efficient recovery of ammonia can be allowed without adding an acid solution to the anode liquid, but the addition of any one selected from the group consisting of sulfuric acid, hydrochloric acid, nitric acid, carbonic acid, and phosphoric acid of 0 M to 1 M to the anode liquid is also within the protection scope of the present disclosure.

The cathode liquid and the anode liquid flow independently in respective flow channels, are not mixed with each other, and flow in opposite directions. The opposite flow directions of the cathode liquid and the anode liquid have a positive effect for the contact, mass transfer, or the like of materials.

Step 2: In the cathode liquid flow chamber at one side of the hydrophobic gas membrane, converting NH₄⁺ in the cathode liquid into NH₃ in an OH⁻ alkaline environment produced at a cathode; and allowing the NH₃ to diffuse to the other side of the hydrophobic gas membrane.

Step 3: Generating a large amount of H⁺ through an electrochemical reaction at an anode, absorbing the NH₃ diffusing from the cathode liquid flow chamber to the anode liquid flow chamber, and finally recovering the ammonia nitrogen in a form of an ammonium salt to complete material recovery from urine.

Optionally, the external DC power supply provides a current with a density of 1 A/m² to 100 A/m², such as 1 A/m², 5 A/m², 10 A/m², 20 A/m², 50 A/m², or 100 A/m² and preferably 20 A/m² to 80 A/m².

Optionally, a residence time of the cathode liquid in the cathode liquid flow chamber is 10 min to 180 min, such as 10 min, 20 min, 40 min, 60 min, 120 min, or 0 min and preferably 30 min to 120 min.

Optionally, in order to increase a recovered ammonia concentration, a residence time of the anode liquid in the anode liquid flow chamber is 10 min to 60 min, such as 10 min, 20 min, 30 min, 40 min, 50 min, or 60 min and preferably 10 min to 30 min.

In the above embodiment, the porous flexible anode is connected with a positive electrode of an external DC power supply through an external metal wire to serve as an anode for an electrochemical reaction, and the porous flexible cathode is connected with a negative electrode of the external DC power supply through an external metal wire to serve as a cathode for the electrochemical reaction. The present disclosure has no special restrictions on the external DC power supply, and any DC power supply or electrochemical workstation that can control a current density may be adopted; and the present disclosure also has no special restrictions on the external metal wire. The present disclosure allows the contact of two substances at opposite sides, and can allow the recovery of a substance in a system. The mass transfer and electrochemical reaction of the roll-type membrane module cooperate with each other to allow the economy and efficiency of electrochemical recovery of ammonia nitrogen. The present disclosure has no special restrictions on a material of the central tube, and the central tube can ensure a mechanical strength of the module and the chemical stability of the module at a pH of 1 to 13.

Optionally, the first flow channel is a serpentine flow channel or a spiral flow channel, and the second flow channel is a serpentine flow channel or a spiral flow channel.

Optionally, a material of the porous flexible cathode includes any one selected from the group consisting of a CC, a porous metal mesh, and a porous foam metal, and has a weaving density of 20 mesh to 300 mesh.

Optionally, a material of the porous flexible anode includes any one selected from the group consisting of a CC, a porous metal mesh, and a porous foam metal, and has a weaving density of 20 mesh to 300 mesh.

Optionally, a material of the hydrophobic gas membrane includes any one selected from the group consisting of polytetrafluoroethylene (PTFE), polyvinylidene fluoride (PVDF), and polypropylene (PP).

Preferably, the porous flexible cathode has a pore size of 100 mesh, and is made of a CC: the porous flexible anode has a pore size of 100 mesh, and is made of a ruthenium-iridium mesh, the hydrophobic gas membrane has a pore size of 0.45 μm, and is made of PTFE; and the guide liners each have a pore size of 60 mesh, and are made of nylon.

In a specific embodiment, optionally, the first partition is a waterproof silicone gasket. In accordance with formation needs of the first flow channel, the waterproof silicone gasket is arranged between corresponding components at a corresponding position in a squeezing manner, such that the first electrode liquid flow chamber is separated into the first flow channel; and corresponding positions of the first guide liner and the first porous flexible electrode are squeezed by the waterproof silicone gasket to allow the formation of the first flow channel.

Optionally, the second partition is also a waterproof silicone gasket. In accordance with formation needs of the second flow channel, the waterproof silicone gasket is arranged between corresponding components at a corresponding position in a squeezing manner, such that the second electrode liquid flow chamber is separated into the second flow channel, and corresponding positions of the second guide liner and the second porous flexible electrode are squeezed by the waterproof silicone gasket to allow the formation of the second flow channel.

The present disclosure has no special restrictions on the AEM, the waterproof silicone gasket, and the guide liners, and commercially-available or self-developed products with corresponding functions may be adopted. The cathode and anode of the present disclosure must be separated by the AEM, and the use of the CEM will significantly decrease a recovery rate of ammonia.

The present disclosure allows the contact of two substances at opposite sides, and can allow the recovery of a substance in a system. The mass transfer and electrochemical reaction of the roll-type membrane module cooperate with each other to allow the economy and efficiency of electrochemical recovery of ammonia nitrogen.

One or more technical solutions in the embodiments of the present disclosure have at least the following technical effects or advantages:

In the present disclosure, an anode liquid flow chamber and a cathode liquid flow chamber form a closed circuit through an AEM at one side, and the anode liquid flow chamber communicates with the cathode liquid flow chamber through a hydrophobic gas membrane at the other side, such that the absorption of ammonia can be conducted entirely with the help of H⁺ generated at an anode, which reduces the costs of chemical agents and materials, greatly improves the efficiency and economy of electrochemical recovery of ammonia, and promotes the development of the field of electrochemical resource recovery. Steps of ammonia conversion in an electrochemical system are reduced to significantly reduce a fugitive loss of ammonia during an air-stripping process. A porous flexible anode, a hydrophobic gas membrane, a porous flexible cathode, and an AEM are assembled in a winding manner to solve the problem that the traditional electrochemical reactor cannot directly use H⁺ generated by an anode to recover ammonia, and to allow green, efficient, and low-energy recovery of ammonia without adding any chemical agent and additionally arranging an acid-producing unit.

Only a two-chamber (namely, a cathode liquid flow chamber and an anode liquid flow chamber) structure is constructed in a multi-layer winding manner to efficiently recover ammonia from urine, domestic wastewater, or breeding wastewater, which overcomes the structural defects of the three-chamber and four-chamber devices disclosed in the prior art, significantly reduces the internal resistance of an electrochemical system, and can allow a high current density of 60 A/m² to 80 A/m² at a low voltage (<5 V) to improve a recovery rate of ammonia.

The AEM only allows anions to pass through, which prevents the reverse-diffusion loss of ammonia and avoids the contamination of a recovered liquid by impurities cations in wastewater. The design of the roll-type device can increase a contact area between an ammonia gas and an acid solution, simplify steps of ammonia conversion, and improve a mass transfer effect while allowing a material circulation process in a system.

The present disclosure can ensure an ammonia nitrogen removal rate of higher than 99% and an ammonia nitrogen recovery rate of higher than 98%, which greatly improves the efficiency and economy of electrochemical recovery of ammonia and promotes the development of the field of electrochemical resource recovery.

### BRIEF DESCRIPTION OF THE DRAWINGS

FIG. 1 is a schematic diagram illustrating a winding structure of the hydrophobic gas membrane 106 and the AEM 109 of the present disclosure and a gas component,

FIG. 2 is a schematic structural diagram of the first electrode liquid flow chamber and the second electrode liquid flow chamber of the present disclosure;

FIG. 3 is a schematic diagram illustrating a cross-sectional structure of the present disclosure;

FIG. 4 is a schematic structural diagram of the central tube of the present disclosure and an external component; and

FIG. 5 is a schematic structural diagram illustrating flow pathways of the cathode liquid and the anode liquid of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

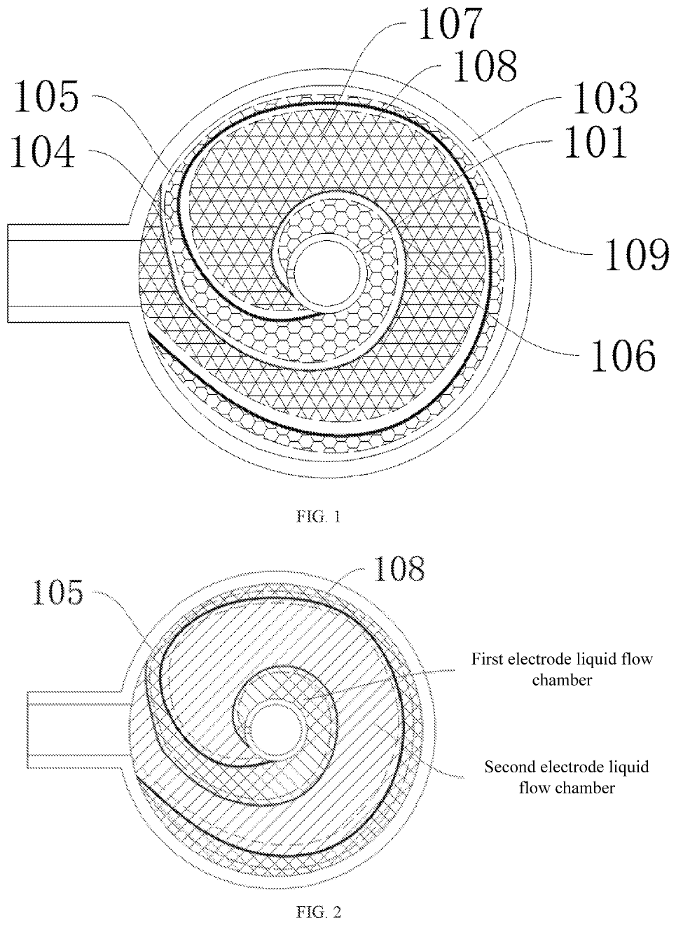

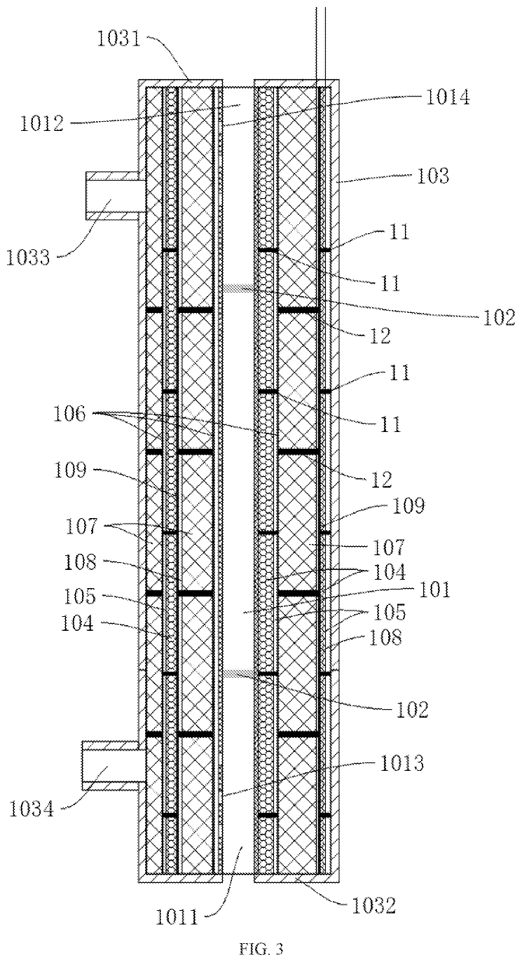

An embodiment of the present disclosure provides a roll-type device for electrochemical recovery of ammonia, as shown in FIG. 1, FIG. 2, and FIG. 3, including central tube 101 and tubular shell 103 sleeved outside the central tube 101. The central tube 101 in this embodiment is not necessary to be cylindrical, and the central tube 101 may also be a rectangular rod-shaped tube, a square tube, a polygonal tube, or the like, as long as construction requirements of first electrode liquid outlet cavity 1012 and first electrode liquid inlet cavity 1011 are met, which are all within the protection scope of the present disclosure. The tubular shell 103 in this embodiment is cylindrically-tubular, but it may be understood that the tubular shell 103 may also be a squarely-cylindrical, polygonally-cylindrical, or the like, which is not limited here. Two axial ends of the tubular shell 103 are provided with end caps 1031 and 1032, respectively, the two end caps are in sealed connection with two ends of the central tube 101, respectively, and the two end caps each are provided with an avoidance hole communicating with the central tube 101;
two partition plates 102 that separate an inner hole of the central tube 101 are provided inside the central tube 101; an axis of the central tube 101 is set as a vertical direction; upper partition plate 102 and an inner wall of the central tube 101 located above the upper partition plate 102 enclose the first electrode liquid outlet cavity 1012 of an upper opening, and lower partition plate 102 and an inner wall of the central tube 101 located below the lower partition plate 102 enclose the first electrode liquid inlet cavity 1011 with a lower opening; the first electrode liquid outlet cavity 1012 and the first electrode liquid inlet cavity 1011 are separated by the partition plates 102, and do not communicate with each other in the central tube 101 to prevent short-circuiting;
hydrophobic gas membrane 106 and AEM 109 are sequentially wound around the central tube 101, the hydrophobic gas membrane 106 and the AEM 109 both are located inside the tubular shell 103, and winding-starting edges of the hydrophobic gas membrane 106 and the AEM 109 both are in sealed connection with an outer wall of the central tube 101; a winding direction of the hydrophobic gas membrane 106 and the AEM 109 around the central tube is set as a clockwise direction; the winding-starting edge of the AEM 109 is located in a counterclockwise direction of the winding-starting edge of the hydrophobic gas membrane 106; first porous flexible electrode 105 and first guide liner 104 are sequentially wound at an inner side of the hydrophobic gas membrane 106, and second porous flexible electrode 108 and second guide liner 107 are sequentially wound at an inner side of the AEM 109; it is understandable that, when a winding angle of the hydrophobic gas membrane 106 exceeds an orientation of the winding-starting edge of the AEM 109, the hydrophobic gas membrane 106 and the first porous flexible electrode 105 and the first guide liner 104 at the inner side of the hydrophobic gas membrane are wound around the AEM 109, such that the AEM 109 is provided at each of inner and outer sides of the hydrophobic gas membrane 106; winding-terminating edges of the hydrophobic gas membrane 106 and the AEM 109 both are in sealed connection with an inner wall of the tubular shell 103; the winding-terminating edge of the AEM 109 is located in a counterclockwise direction of the winding-terminating edge of the hydrophobic gas membrane 106; edges of upper and lower ends of each of the hydrophobic gas membrane 106 and the AEM 109 each are in sealed connection with the end caps of the two axial ends of the tubular shell 103, such that an inner side wall of the hydrophobic gas membrane 106, an outer wall of the central tube extending from the winding-starting edge of the hydrophobic gas membrane 106 in the clockwise direction, an outer side wall of the AEM 109, and an inner wall of the tubular shell 103 enclose closed first electrode liquid flow chamber, and an inner side wall of the AEM 109, an outer wall of the central tube extending from the winding-starting edge of the AEM 109 in the clockwise direction, an outer side wall of the hydrophobic gas membrane 106, and an inner wall of the tubular shell 103 enclose closed second electrode liquid flow chamber;
first partition 11 is provided inside the first electrode liquid flow chamber, and the first partition 11 separates the first electrode liquid flow chamber into a first flow channel, namely, a first electrode liquid flow channel, which can prevent the leakage and mixing of a first electrode liquid,
second partition 12 is provided inside the second electrode liquid flow chamber, and the second partition 12 separates the second electrode liquid flow chamber into a second flow channel, namely, a second electrode liquid flow channel, which can prevent the leakage and mixing of a second electrode liquid;
the first partition 11 and the first guide liner 104 provide water-distributing and supporting effects for the first electrode liquid flow chamber, and the first guide liner 104 can ensure a uniform flow of an electrode liquid on a porous flexible electrode;
the second partition 12 and the second guide liner 107 provide water-distributing and supporting effects for the second electrode liquid flow chamber, and the second guide liner 107 can ensure a uniform flow of an electrode liquid on a porous flexible electrode;
a top of a side wall of the central tube 101 is provided with outlet hole 1014 allowing the first electrode liquid outlet cavity 1012 to communicate with the first flow channel, and a bottom of the side wall of the central tube 101 is provided with inlet hole 1013 allowing the first electrode liquid inlet cavity 1011 to communicate with the first flow channel;
a first electrode liquid enters the first electrode liquid flow chamber through the inlet hole 1013 at the bottom of the central tube 101, flows from bottom to top, exits the first electrode liquid flow chamber through the outlet hole 1014 at the top of the central tube 101, and flows out through the first electrode liquid outlet cavity 1012;
an upper part of a side wall of the tubular shell 103 is provided with second electrode liquid inlet 1033 communicating with the second flow channel, and a lower part of the side wall of the tubular shell 103 is provided with second electrode liquid outlet 1034 communicating with the second flow channel; and a second electrode liquid flows in through the second electrode liquid inlet 1033, flows from top to bottom, and flows out through the second electrode liquid outlet 1034.

In the present disclosure, a first electrode liquid flows from the first electrode liquid inlet cavity 1011 of the central tube 101 into the first electrode liquid flow chamber at an inner side; a second electrode liquid is injected into the second electrode liquid inlet 1033 from an upper side end of the tubular shell, and flows into the second electrode liquid flow chamber; and the first electrode liquid and the second electrode liquid flow independently in respective flow chambers, and are not mixed with each other. In addition, the second electrode liquid flow chamber and the first electrode liquid flow chamber form a closed circuit through the AEM at a side of the second electrode liquid flow chamber.

Optionally, the first electrode liquid is a cathode liquid, the first electrode liquid flow chamber is a cathode liquid flow chamber, the first electrode liquid inlet cavity is a cathode liquid inlet cavity, the first electrode liquid outlet cavity is a cathode liquid outlet cavity, and the first porous flexible electrode 105 is a porous flexible cathode; and
the second electrode liquid is an anode liquid, the second electrode liquid flow chamber is an anode liquid flow chamber, the second electrode liquid inlet 1033 is an anode liquid inlet, the second electrode liquid outlet 1034 is an anode liquid outlet, and the second porous flexible electrode 108 is a porous flexible anode.

In this case, in the cathode liquid flow chamber at an inner side of the central tube 101, a large amount of OH⁻ is generated near the porous flexible cathode 105 due to an electrochemical reduction reaction to increase a pH of the cathode liquid to 9.3 or more (more than pKₐ (NH₃/NH₄⁺)=9.25) such that NH₄⁺ in the cathode liquid is converted into NH₃, and then NH₃ diffuses to the anode liquid flow chamber through the hydrophobic gas membrane 106 and is captured by H⁺ generated near the porous flexible anode 108 to produce NH₄⁺; and anions (such as Cl⁻ and SO₄²⁻) in the cathode liquid enter the anode liquid flow chamber through the AEM 109, thereby allowing a charge balance and the recycling of ammonia.

A method for electrochemical recovery of ammonia with the roll-type device for electrochemical recovery of ammonia is provided, including the following steps:

Step 1. A hydrolyzed cathode liquid is introduced from the cathode liquid inlet cavity 1011 of the central tube 101 into the first flow channel of the cathode liquid flow chamber through the inlet hole 1013. The cathode liquid includes any one selected from the group consisting of urine, domestic wastewater, and breeding wastewater, and has an ammonia nitrogen concentration of 30 mg/L to 5,000 mg/L, such as 50 mg/L, 100 mg/L, 200 mg/L, 500 mg/L, 1,000 mg/L, or 2,000 mg/L and preferably 100 mg/L to 4,000 mg/L; and the ammonia nitrogen concentration is determined based on N. The cathode liquid in this embodiment is urine (with an ammonia nitrogen concentration of 2,000 mg/L).

An anode liquid is introduced into the anode liquid flow chamber through the anode liquid inlet 1033 at an outer upper end of the tubular shell 103. The anode liquid includes any one selected from the group consisting of tap water, deionized water, and UPW. The device and method of the present disclosure ensure that the efficient recovery of ammonia can be allowed without adding an acid solution to the anode liquid, but the addition of any one selected from the group consisting of sulfuric acid, hydrochloric acid, nitric acid, carbonic acid, and phosphoric acid of 0 M to 1 M to the anode liquid is also within the protection scope of the present disclosure. The anode liquid in this embodiment is tap water.

The cathode liquid and the anode liquid flow independently in respective flow channels, are not mixed with each other, and flow in opposite directions.

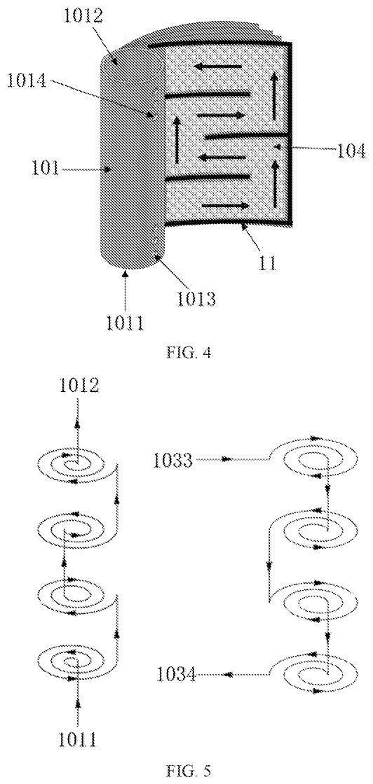

In this step, specific flow directions of the liquids in the two chambers are shown in FIG. 5, where a flow direction of the cathode liquid is shown at a left panel of FIG. 5 and a flow direction of the anode liquid is shown at a right panel of FIG. 5. The opposite flow directions of the cathode liquid and the anode liquid have a positive effect for the contact, mass transfer, or the like of materials.

Step 2. In the cathode liquid flow chamber enclosed by an outer side of the central tube 101 and the hydrophobic gas membrane 106, NH₄⁺ in the cathode liquid is converted into NH₃ in an OH⁻ alkaline environment produced at a cathode; and the NH₃ is allowed to diffuse to the anode liquid flow chamber enclosed by the hydrophobic gas membrane 106 and the AEM 109.

Step 3: A large amount of H⁺ is generated through an electrochemical reaction at an anode, the NH₃ diffusing from the cathode liquid flow chamber to the anode liquid flow chamber is absorbed, and finally the ammonia nitrogen is recovered in a form of an ammonium salt to complete material recovery from urine.

Optionally, the external DC power supply provides a current with a density of 1 A/m² to 100 A/m², such as 1 A/m², 5 A/m², 10 A/m², 20 A/m², 50 A/m², or 100 A/m² and preferably 20 A/m² to 80 A/m². In this embodiment, the DC power supply provides a current with a density of 80 A/m².

Optionally, a residence time of the cathode liquid in the cathode liquid flow chamber is 10 min to 180 min, such as 10 min, 20 min, 40 min, 60 min, 120 min, or 0 min and preferably 30 min to 120 min. In this embodiment, a residence time of the cathode liquid in the cathode liquid flow chamber is 120 min.

Optionally, in order to increase a recovered ammonia concentration, a residence time of the anode liquid in the anode liquid flow chamber is 10 min to 60 min, such as 10 min, 20 min, 30 min, 40 min, 50 min, or 60 min and preferably 10 min to 30 min. In this embodiment, a residence time of the anode liquid in the anode liquid flow chamber is 30 min.

In this embodiment, a removal rate of ammonia nitrogen is 99%, a recovery rate of ammonia nitrogen is 98%, and an ammonia concentration of a recovered liquid is 7,760 mg/L.

Optionally, the first electrode liquid is an anode liquid, the first electrode liquid flow chamber is an anode liquid flow chamber, the first electrode liquid inlet cavity is an anode liquid inlet cavity, the first electrode liquid outlet cavity is an anode liquid outlet cavity, and the first porous flexible electrode 105 is a porous flexible anode; and
the second electrode liquid is a cathode liquid, the second electrode liquid flow chamber is a cathode liquid flow chamber, the second electrode liquid inlet 1033 is a cathode liquid inlet, the second electrode liquid outlet 1034 is a cathode liquid outlet, and the second porous flexible electrode 108 is a porous flexible cathode.

In this case, in the cathode liquid flow chamber at an outer side, a large amount of OH″ is generated near the porous flexible cathode 108 due to an electrochemical reduction reaction to increase a pH of the cathode liquid to 9.3 or more (more than pKₐ(NH₃/NH₄⁺)=9.25) such that NH₄⁺ in the cathode liquid is converted into NH₃, and then NH₃ diffuses to the anode liquid flow chamber through the hydrophobic gas membrane 106 and is captured by H⁺ generated near the porous flexible anode 105 to produce NH₄⁺; and anions (such as Cl⁻ and SO₄²⁻) in the cathode liquid enter the anode liquid flow chamber through the AEM 109, thereby allowing a charge balance and the recycling of ammonia.

A method for electrochemical recovery of ammonia with the roll-type device for electrochemical recovery of ammonia is provided, including the following steps:

Step 1: A hydrolyzed cathode liquid is introduced into the second flow channel of the cathode liquid flow chamber through the cathode liquid inlet 1033 at the upper part of the side wall of the tubular shell 103. The cathode liquid includes any one selected from the group consisting of urine, domestic wastewater, and breeding wastewater, and has an ammonia nitrogen concentration of 30 mg/L to 5,000 mg/L, such as 50 mg/L, 100 mg/L, 200 mg/L, 500 mg/L, 1,000 mg/L, or 2,000 mg/L and preferably 100 mg/L to 4,000 mg/L; and the ammonia nitrogen concentration is determined based on N. The cathode liquid in this embodiment is urine (with an ammonia nitrogen concentration of 2,000 mg/L).

An anode liquid is introduced from the anode liquid inlet cavity 1011 of the central tube 101 into the first flow channel of the anode liquid flow chamber through the inlet hole 1013. The anode liquid includes any one selected from the group consisting of tap water, deionized water, and UPW. The device and method of the present disclosure ensure that the efficient recovery of ammonia can be allowed without adding an acid solution to the anode liquid, but the addition of any one selected from the group consisting of sulfuric acid, hydrochloric acid, nitric acid, carbonic acid, and phosphoric acid of 0 M to 1 M to the anode liquid is also within the protection scope of the present disclosure. The anode liquid in this embodiment is tap water.

The cathode liquid and the anode liquid flow independently in respective flow channels, are not mixed with each other, and flow in opposite directions. The opposite flow directions of the cathode liquid and the anode liquid have a positive effect for the contact, mass transfer, or the like of materials.

Step 2: In the cathode liquid flow chamber at one side of the hydrophobic gas membrane, NH₄⁺ in the cathode liquid is converted into NH₃ in an OH⁻ alkaline environment produced at a cathode; and the NH₃ is allowed to diffuse to the other side of the hydrophobic gas membrane 106.

Step 3: A large amount of H⁺ is generated through an electrochemical reaction at an anode, the NH₃ diffusing from the cathode liquid flow chamber to the anode liquid flow chamber is absorbed, and finally the ammonia nitrogen is recovered in a form of an ammonium salt to complete material recovery from urine.

Optionally, the external DC power supply provides a current with a density of 1 A/m² to 100 A/m², such as 1 A/m², 5 A/m², 10 A/m², 20 A/m², 50 A/m², or 100 A/m² and preferably 20 A/m² to 80 A/m². In this embodiment, the DC power supply provides a current with a density of 80 A/m².

Optionally, a residence time of the cathode liquid in the cathode liquid flow chamber is 10 min to 180 min, such as 10 min, 20 min, 40 min, 60 min, 120 min, or 0 min and preferably 30 min to 120 min. In this embodiment, a residence time of the cathode liquid in the cathode liquid flow chamber is 120 min.

Optionally, in order to increase a recovered ammonia concentration, a residence time of the anode liquid in the anode liquid flow chamber is 10 min to 60 min, such as 10 min, 20 min, 30 min, 40 min, 50 min, or 60 min and preferably 10 min to 30 min. In this embodiment, a residence time of the anode liquid in the anode liquid flow chamber is 30 min.

In this embodiment, a removal rate of ammonia nitrogen is 99%, a recovery rate of ammonia nitrogen is 98%, and an ammonia concentration of a recovered liquid is 7,760 mg/L.

In the above embodiment, the porous flexible anode is connected with a positive electrode of an external DC power supply through an external metal wire to serve as an anode for an electrochemical reaction, and the porous flexible cathode is connected with a negative electrode of the external DC power supply through an external metal wire to serve as a cathode for the electrochemical reaction. The present disclosure has no special restrictions on the external DC power supply, and any DC power supply or electrochemical workstation that can control a current density may be adopted, and the present disclosure also has no special restrictions on the external metal wire. The present disclosure allows the contact of two substances at opposite sides, and can allow the recovery of a substance in a system. The mass transfer and electrochemical reaction of the roll-type membrane module cooperate with each other to allow the economy and efficiency of electrochemical recovery of ammonia nitrogen.

The present disclosure has no special restrictions on a material of the central tube 101, and the central tube 101 can ensure a mechanical strength of the module and the chemical stability of the module at a pH of 1 to 13.

Optionally, the first flow channel is a serpentine flow channel or a spiral flow channel, and the second flow channel is a serpentine flow channel or a spiral flow channel.

Optionally, a material of the porous flexible cathode includes any one selected from the group consisting of a CC, a porous metal mesh, and a porous foam metal, and has a weaving density of 20 mesh to 300 mesh.

Optionally, a material of the porous flexible anode includes any one selected from the group consisting of a CC, a porous metal mesh, and a porous foam metal, and has a weaving density of 20 mesh to 300 mesh.

Optionally, a material of the hydrophobic gas membrane includes any one selected from the group consisting of PTFE, PVDF, and PP.

Preferably, the porous flexible cathode has a pore size of 100 mesh, and is made of a CC; the porous flexible anode has a pore size of 100 mesh, and is made of a ruthenium-iridium mesh; the hydrophobic gas membrane 106 has a pore size of 0.45 μm, and is made of PTFE; and the guide liners each have a pore size of 60 mesh, and are made of nylon.

In a specific embodiment, optionally, the first partition 11 is a waterproof silicone gasket. As shown in FIG. 4, in accordance with formation needs of the first flow channel, the waterproof silicone gasket is arranged between corresponding components at a corresponding position in a squeezing manner, such that the first electrode liquid flow chamber is separated into the first flow channel, and corresponding positions of the first guide liner 104 and the first porous flexible electrode 105 are squeezed by the waterproof silicone gasket to allow the formation of the first flow channel.

Optionally, the second partition 12 is also a waterproof silicone gasket. In accordance with formation needs of the second flow channel, the waterproof silicone gasket is arranged between corresponding components at a corresponding position in a squeezing manner, such that the second electrode liquid flow chamber is separated into the second flow channel; and corresponding positions of the second guide liner 107 and the second porous flexible electrode 108 are squeezed by the waterproof silicone gasket to allow the formation of the second flow channel.

The present disclosure has no special restrictions on the AEM 109, the waterproof silicone gasket, and the guide liners, and commercially-available or self-developed products with corresponding functions may be adopted. The cathode and anode of the present disclosure must be separated by the AEM 109, and the use of the CEM will significantly decrease a recovery rate of ammonia.

The present disclosure allows the contact of two substances at opposite sides, and can allow the recovery of a substance in a system. The mass transfer and electrochemical reaction of the roll-type membrane module cooperate with each other to allow the economy and efficiency of electrochemical recovery of ammonia nitrogen.

It should be noted that the above embodiments are provided to illustrate rather than limit the present disclosure, and those skilled in the art can design alternative embodiments without departing from the scope of the appended claims. In the claims, any reference sign between brackets should not be construed as a limitation to the claims. The term “include” or “comprise” does not exclude the presence of elements or steps not listed in the claims. The term “one” or “a/an” preceding an element does not exclude the presence of multiple such elements. The terms such as “first”, “second”, and “third” do not indicate any order, and can be interpreted as names.

All features disclosed in this specification, except those that are mutually exclusive, can be combined with each other in any way.

Unless otherwise specifically stated, any feature disclosed in this specification (including any appended claims, abstract, and accompanying drawings) may be replaced by other alternative features with equivalent or similar purposes. That is, unless otherwise specifically stated, each feature is just one example of a series of equivalent or similar features.

The present disclosure is not limited to the above specific embodiments. The present disclosure extends to any new feature or any new combination disclosed in this specification, and any new method or process step or any new combination disclosed.

What is claimed is:

1. A roll-type device for an electrochemical recovery of ammonia, comprising: a central tube and a tubular shell sleeved outside the central tube, wherein two axial ends of the tubular shell are provided with two end caps, respectively, the two end caps are in a sealed connection with two ends of the central tube, respectively, and the two end caps each are provided with an avoidance hole communicating with the central tube;
two partition plates separating an inner hole of the central tube are provided inside the central tube, an axis of the central tube is set as a vertical direction, an upper partition plate of the two partition plates and an inner wall of the central tube located above the upper partition plate enclose a first electrode liquid outlet cavity with an upper opening, and a lower partition plate of the two partition plates and an inner wall of the central tube located below the lower partition plate enclose a first electrode liquid inlet cavity with a lower opening; the first electrode liquid outlet cavity and the first electrode liquid inlet cavity are separated by the two partition plates;
a hydrophobic gas membrane and an anion-exchange membrane (AEM) are sequentially wound around the central tube, the hydrophobic gas membrane and the AEM are located inside the tubular shell, and a winding-starting edge of the hydrophobic gas membrane and a winding-starting edge of the AEM are in a sealed connection with an outer wall of the central tube; a winding direction of the hydrophobic gas membrane and the AEM around the central tube is set as a clockwise direction; the winding-starting edge of the AEM is located in a counterclockwise direction of the winding-starting edge of the hydrophobic gas membrane, a first porous flexible electrode and a first guide liner are sequentially wound at an inner side of the hydrophobic gas membrane, and a second porous flexible electrode and a second guide liner are sequentially wound at an inner side of the AEM; a winding-terminating edge of the hydrophobic gas membrane and a winding-terminating edge of the AEM are in a sealed connection with an inner wall of the tubular shell; the winding-terminating edge of the AEM is located in a counterclockwise direction of the winding-terminating edge of the hydrophobic gas membrane; edges of upper and lower ends of each of the hydrophobic gas membrane and the AEM are in a sealed connection with the two end caps of the two axial ends of the tubular shell, such that an inner side wall of the hydrophobic gas membrane, an outer wall of the central tube extending from the winding-starting edge of the hydrophobic gas membrane in the clockwise direction, an outer side wall of the AEM, and the inner wall of the tubular shell enclose a closed first electrode liquid flow chamber, and an inner side wall of the AEM, an outer wall of the central tube extending from the winding-starting edge of the AEM in the clockwise direction, an outer side wall of the hydrophobic gas membrane, and the inner wall of the tubular shell enclose a closed second electrode liquid flow chamber;
a first partition is provided inside the closed first electrode liquid flow chamber, and the first partition separates the closed first electrode liquid flow chamber into a first flow channel;
a second partition is provided inside the closed second electrode liquid flow chamber, and the second partition separates the closed second electrode liquid flow chamber into a second flow channel;
a top of a side wall of the central tube is provided with an outlet hole allowing the first electrode liquid outlet cavity to communicate with the first flow channel, and a bottom of the side wall of the central tube is provided with an inlet hole allowing the first electrode liquid inlet cavity to communicate with the first flow channel;
a first electrode liquid enters the closed first electrode liquid flow chamber through the inlet hole at the bottom of the central tube, flows from a bottom to a top, exits the closed first electrode liquid flow chamber through the outlet hole at the top of the central tube, and flows out through the first electrode liquid outlet cavity, and
an upper part of a side wall of the tubular shell is provided with a second electrode liquid inlet communicating with the second flow channel, and a lower part of the side wall of the tubular shell is provided with a second electrode liquid outlet communicating with the second flow channel; and a second electrode liquid flows in through the second electrode liquid inlet, flows from the top to the bottom, and flows out through the second electrode liquid outlet.

2. The roll-type device for the electrochemical recovery of the ammonia according to claim 1, wherein the first electrode liquid is a cathode liquid, the closed first electrode liquid flow chamber is a cathode liquid flow chamber, the first electrode liquid inlet cavity is a cathode liquid inlet cavity, the first electrode liquid outlet cavity is a cathode liquid outlet cavity, and the first porous flexible electrode is a porous flexible cathode; and
the second electrode liquid is an anode liquid, the closed second electrode liquid flow chamber is an anode liquid flow chamber, the second electrode liquid inlet is an anode liquid inlet, the second electrode liquid outlet is an anode liquid outlet, and the second porous flexible electrode is a porous flexible anode.

3. The roll-type device for the electrochemical recovery of the ammonia according to claim 2, wherein the porous flexible anode is connected with a positive electrode of an external direct current (DC) power supply through a first external metal wire to serve as an anode for an electrochemical reaction, and the porous flexible cathode is connected with a negative electrode of the external DC power supply through a second external metal wire to serve as a cathode for the electrochemical reaction.

4. The roll-type device for the electrochemical recovery of the ammonia according to claim 2, wherein each of the first flow channel and the second flow channel is a serpentine flow channel or a spiral flow channel.

5. The roll-type device for the electrochemical recovery of the ammonia according to claim 2, wherein a material of the porous flexible cathode comprises one selected from the group consisting of a carbon cloth (CC), a porous metal mesh, and a porous foam metal, and has a weaving density of 20 mesh to 300 mesh.

6. The roll-type device for the electrochemical recovery of the ammonia according to claim 2, wherein a material of the porous flexible anode comprises one selected from the group consisting of a CC, a porous metal mesh, and a porous foam metal, and has a weaving density of 20 mesh to 300 mesh.

7. The roll-type device for the electrochemical recovery of the ammonia according to claim 2, wherein a material of the hydrophobic gas membrane comprises one selected from the group consisting of polytetrafluoroethylene (PTFE), polyvinylidene fluoride (PVDF), and polypropylene (PP).

8. The roll-type device for the electrochemical recovery of the ammonia according to claim 2, wherein the porous flexible cathode has a pore size of 100 mesh, and is made of a CC; the porous flexible anode has a pore size of 100 mesh, and is made of a ruthenium-iridium mesh; the hydrophobic gas membrane has a pore size of 0.45 μm, and is made of PTFE; and the first guide liner and the second guide liner each have a pore size of 60 mesh, and are made of nylon.

9. The roll-type device for the electrochemical recovery of the ammonia according to claim 2, wherein each of the first partition and the second partition is a waterproof silicone gasket.

10. The roll-type device for the electrochemical recovery of the ammonia according to claim 2, wherein the cathode liquid comprises one selected from the group consisting of urine, domestic wastewater, and breeding wastewater, and has an ammonia nitrogen concentration of 30 mg/L to 5,000 mg/L; and the ammonia nitrogen concentration is determined based on N.

11. The roll-type device for the electrochemical recovery of the ammonia according to claim 10, wherein the ammonia nitrogen concentration is 100 mg/L to 4,000 mg/L.

12. The roll-type device for the electrochemical recovery of the ammonia according to claim 2, wherein the anode liquid comprises one selected from the group consisting of tap water, deionized water, and ultrapure water (UPW).

13. The roll-type device for the electrochemical recovery of the ammonia according to claim 12, wherein in the anode liquid, one selected from the group consisting of sulfuric acid, hydrochloric acid, nitric acid, carbonic acid, and phosphoric acid of 0 M to 1 M is added.

14. The roll-type device for the electrochemical recovery of the ammonia according to claim 3, wherein the external DC power supply provides a current with a density of 1 A/m² to 100 A/m².

15. The roll-type device for the electrochemical recovery of the ammonia according to claim 14, wherein the external DC power supply provides the current with the density of 20 A/m² to 80 A/m².

16. The roll-type device for the electrochemical recovery of the ammonia according to claim 2, wherein a residence time of the cathode liquid in the cathode liquid flow chamber is 10 min to 180 min.

17. The roll-type device for the electrochemical recovery of the ammonia according to claim 16, wherein the residence time of the cathode liquid in the cathode liquid flow chamber is 30 min to 120 min.

18. The roll-type device for the electrochemical recovery of the ammonia according to claim 2, wherein a residence time of the anode liquid in the anode liquid flow chamber is 10 min to 60 min.

19. The roll-type device for the electrochemical recovery of the ammonia according to claim 18, wherein the residence time of the anode liquid in the anode liquid flow chamber is 10 min to 30 min.

20. The roll-type device for the electrochemical recovery of the ammonia according to claim 1, wherein
the first electrode liquid is an anode liquid, the closed first electrode liquid flow chamber is an anode liquid flow chamber, the first electrode liquid inlet cavity is an anode liquid inlet cavity, the first electrode liquid outlet cavity is an anode liquid outlet cavity, and the first porous flexible electrode is a porous flexible anode; and
the second electrode liquid is a cathode liquid, the closed second electrode liquid flow chamber is a cathode liquid flow chamber, the second electrode liquid inlet is a cathode liquid inlet, the second electrode liquid outlet is a cathode liquid outlet, and the second porous flexible electrode is a porous flexible cathode.

21. The roll-type device for the electrochemical recovery of the ammonia according to claim 20, wherein the porous flexible anode is connected with a positive electrode of an external DC power supply through a first external metal wire to serve as an anode for an electrochemical reaction, and the porous flexible cathode is connected with a negative electrode of the external DC power supply through a second external metal wire to serve as a cathode for the electrochemical reaction.

22. The roll-type device for the electrochemical recovery of the ammonia according to claim 20, wherein each of the first flow channel and the second flow channel is a serpentine flow channel or a spiral flow channel.

23. The roll-type device for the electrochemical recovery of the ammonia according to claim 20, wherein a material of the porous flexible cathode comprises one selected from the group consisting of a CC, a porous metal mesh, and a porous foam metal, and has a weaving density of 20 mesh to 300 mesh.

24. The roll-type device for the electrochemical recovery of the ammonia according to claim 20, wherein a material of the porous flexible anode comprises one selected from the group consisting of a CC, a porous metal mesh, and a porous foam metal, and has a weaving density of 20 mesh to 300 mesh.

25. The roll-type device for the electrochemical recovery of the ammonia according to claim 20, wherein a material of the hydrophobic gas membrane comprises one selected from the group consisting of PTFE, PVDF, and PP.

26. The roll-type device for the electrochemical recovery of the ammonia according to claim 20, wherein the porous flexible cathode has a pore size of 100 mesh, and is made of a CC; the porous flexible anode has a pore size of 100 mesh, and is made of a ruthenium-iridium mesh; the hydrophobic gas membrane has a pore size of 0.45 μm, and is made of PTFE; and the first guide liner and the second guide liner each have a pore size of 60 mesh, and are made of nylon.

27. The roll-type device for the electrochemical recovery of the ammonia according to claim 20, wherein each of the first partition and the second partition is a waterproof silicone gasket.

28. The roll-type device for the electrochemical recovery of the ammonia according to claim 20, wherein the cathode liquid comprises one selected from the group consisting of urine, domestic wastewater, and breeding wastewater, and has an ammonia nitrogen concentration of 30 mg/L to 5,000 mg/L; and the ammonia nitrogen concentration is determined based on N.

29. The roll-type device for the electrochemical recovery of the ammonia according to claim 28, wherein the ammonia nitrogen concentration is 100 mg/L to 4,000 mg/L.

30. The roll-type device for the electrochemical recovery of the ammonia according to claim 20, wherein the anode liquid comprises one selected from the group consisting of a tap water, a deionized water, and an UPW.

31. The roll-type device for the electrochemical recovery of the ammonia according to claim 30, wherein in the anode liquid, one selected from the group consisting of sulfuric acid, hydrochloric acid, nitric acid, carbonic acid, and phosphoric acid of 0 M to 1 M is added.

32. The roll-type device for the electrochemical recovery of the ammonia according to claim 21, wherein the external DC power supply provides a current with a density of 1 A/m² to 100 A/m².

33. The roll-type device for the electrochemical recovery of the ammonia according to claim 32, wherein the external DC power supply provides the current with the density of 20 A/m² to 80 A/m².

34. The roll-type device for the electrochemical recovery of the ammonia according to claim 20, wherein a residence time of the cathode liquid in the cathode liquid flow chamber is 10 min to 180 min.

35. The roll-type device for the electrochemical recovery of the ammonia according to claim 34, wherein the residence time of the cathode liquid in the cathode liquid flow chamber is 30 min to 120 min.

36. The roll-type device for the electrochemical recovery of the ammonia according to claim 20, wherein a residence time of the anode liquid in the anode liquid flow chamber is 10 min to 60 min.

37. The roll-type device for the electrochemical recovery of the ammonia according to claim 36, wherein the residence time of the anode liquid in the anode liquid flow chamber is 10 min to 30 min.

38. A method for an electrochemical recovery of ammonia with the roll-type device for the electrochemical recovery of the ammonia according to claim 2, comprising the following steps:
step 1: introducing a hydrolyzed cathode liquid from the cathode liquid inlet cavity of the central tube into the first flow channel of the cathode liquid flow chamber through the inlet hole, and introducing the anode liquid into the anode liquid flow chamber through the anode liquid inlet at an outer upper end of the tubular shell, wherein the hydrolyzed cathode liquid and the anode liquid flow independently in respective flow channels, are not mixed with each other, and flow in opposite directions;
step 2: in the cathode liquid flow chamber enclosed by an outer side of the central tube and the hydrophobic gas membrane, converting NH₄⁺ in the hydrolyzed cathode liquid into NH₃ in an OH⁻ alkaline environment produced at a cathode; and allowing the NH₃ to diffuse to the anode liquid flow chamber enclosed by the hydrophobic gas membrane and the AEM; and
step 3: generating a large amount of H⁺ through an electrochemical reaction at an anode, absorbing the NH₃ diffusing from the cathode liquid flow chamber to the anode liquid flow chamber, and finally recovering an ammonia nitrogen in a form of an ammonium salt to complete a material recovery from urine.

39. A method for an electrochemical recovery of ammonia with the roll-type device for the electrochemical recovery of the ammonia according to claim 20, comprising the following steps:
step 1: introducing a hydrolyzed cathode liquid into the second flow channel of the cathode liquid flow chamber through the cathode liquid inlet at the upper part of the side wall of the tubular shell, and introducing the anode liquid from the anode liquid inlet cavity of the central tube into the first flow channel of the anode liquid flow chamber through the inlet hole, wherein the hydrolyzed cathode liquid and the anode liquid flow independently in respective flow channels, are not mixed with each other, and flow in opposite directions;
step 2: in the cathode liquid flow chamber at a first side of the hydrophobic gas membrane, converting NH₄⁺ in the hydrolyzed cathode liquid into NH₃ in an OH alkaline environment produced at a cathode; and allowing the NH₃ to diffuse to a second side of the hydrophobic gas membrane; and
step 3: generating a large amount of H⁺ through an electrochemical reaction at an anode, absorbing the NH₃ diffusing from the cathode liquid flow chamber to the anode liquid flow chamber, and finally recovering an ammonia nitrogen in a form of an ammonium salt to complete a material recovery from urine.
